(19) United States
(12) Patent Application Publication
(10) Pub. No.: US 2006/0246408 A1
(43) Pub. Date: Nov. 2, 2006

(54) Receiver device for karaoke

(75) Inventor: Jianping Gao, Shanghai (CN)

Correspondence Address: Raymond Y. Chan, Suite 128, 108 N. Ynez Avenue, Monterey Park, CA, 91754, US

(73) Assignee: Shanghai Multak Technology Development Co., Ltd.

(21) Appl. No.: 11/400,149

(22) Filed: Apr. 6, 2006

(30) Foreign Application Priority Data
Apr. 6, 2005 (CN) 200510024905.3

(51) Int. Cl. G09B 5/00

(52) U.S. Cl. 434/307 A

(57) ABSTRACT

The present invention provides a karaoke receiving device which is capable of simultaneously supporting the voice and data signals entering in a wireless manner with two sets of wireless microphones. The singer's voice data are being processed and mixed together with the background music and then transferred to an amplifier or a television or other similar audio devices. It is also possible to control the song selecting, playback, recording and similar karaoke feature by the wireless microphone keypad control. The images and lyrics signals are transferred to a display monitor from the video encoder after the data encoding. In addition, the present invention eliminates the connecting cable between the karaoke microphone and the television and also reduces the size of the microphone. Therefore, the present invention is more convenient and provides a more enjoyable experience for the users.

### BACKGROUND OF THE PRESENT INVENTION

1. Field of invention

The present invention relates to a karaoke entertainment machine, and more particularly to a karaoke receiving device communicatively linking to an entertainment system.

2. Description of Related Arts

Karaoke singing is very popular among the culture nowadays because it allows people to listen to some of their favorite songs. And in addition, it allows people to sing the song along with the background music without the original singer's singing. Karaoke provides a chance for people to show off their singing ability to sing along with the background music just like the way professional singers do.

Conventional karaoke singing is performed by a karaoke machine, wherein the song data are read from LD, VCD, or DVD etc. Regarding to such a conventional karaoke machine, the size of it is relatively big and therefore it is inconvenient for transportation. In addition, each disc storage capacity is small, and usually can only store about twenty songs.

Our company has designed a karaoke microphone (CHINA patent: 2005100223918.9). The karaoke microphone can provide background images, lyrics, instrumental music, and original song with the singer's performance and all other conventional karaoke machine function. The karaoke microphone is ready to be in use when a cable is connected between the karaoke microphone and the television. In addition, a small storage media card can store thousands of songs. The karaoke microphone also has a USB port connection which can transfer data with a computer.

This kind of karaoke microphone is inconvenient and unsafe because a cable must be connected between the karaoke microphone and the television. It could be dangerous for the user to trip over the cable which is lying on the floor. In addition, because all the units and devices are integrated into the microphone, the size of the karaoke microphone is relatively large. Therefore, the weight is heavy and it affects the comfort level of the karaoke microphone to the users.

### SUMMARY OF THE PRESENT INVENTION

A main object of the present invention is to provide a karaoke receiving device which overcomes the disadvantages of the karaoke microphone as described above. The karaoke receiving device connects with a wireless microphone so it can provide a convenient, easy to use, and enjoyable karaoke experience.

Accordingly, in order to accomplish the above objects, the present invention provides a karaoke receiving device adapted for wirelessly communicating a microphone to a video/audio system, comprising

a data analyzer which comprises a data decoder which is capable of decoding compressed digital data into video data and background audio data, a video encoder which is capable of encoding video data into video signal outputting to the video/audio system;

a volume controller adapted for controlling a volume input from the microphone;

an audio processor module which comprises an audio mixing module electrically communicating with the data analyzer to process the background audio data therefrom; and

a receiving unit, which is wirelessly communicating with the microphone, wherein the receiving unit is adapted for receiving an outputting signal from the microphone and for converting the outputting signal into a digital control signal and a voice signal, wherein the audio processor module processes the voice signal to mix with the background audio data and outputs to the video/audio system.

The receiving unit, which is also a dual channel receiving unit, comprises a separating circuit to separate the outputting signal of the microphone to become two gateway signals, a decoding circuit to decode each of gateway signals, and a communication circuit transmitting the digital control signal to the data analyzer. After breaking down the outputting signal, the two gateway signals pass through the decoding circuit to form the digital control signal and the voice signal respectively. Then, the volume of the voice signal can be controlled by the volume controller. The digital control signal is sent to the data analyzer by the communication circuit.

The audio processor module further comprises a balance controller which can automatically balance the voice signal and background audio data.

The audio mixing module further comprises a decompressing MMD processor which is capable of increasing the storing capacity of the audio mixing module.

The data analyzer further comprises a card reader which is electrically connected to the data decoder. The card reader is used to read the compressed digital data.

The karaoke receiving device further comprises an internal data storage device which is communicatively connected to the data decoder. The internal data storage device is used to store the compressed digital data before the processing. The internal data storage device further comprises a computer connecting port which is capable of transferring data between a computer and the internal data storage device.

The karaoke receiving device further comprises a control unit which is connected to the data analyzer. The control unit receives an infrared signal from an external infrared remote control and then transfers the signal to the data analyzer to execute playback, recording, selecting song and other similar function.

The karaoke receiving device further comprises a USB port which can be electronically connected to the internal data storage device or a computer. The USB port is used to store songs and background images downloaded from a computer. The USB port also supports read and write function for a USB storage device which is capable of storing song, background image, and recording data into the USB storage device.

The card reader employs CARD CPU and the basic standards of ROM, NOR FLASH, SIO used by CARD CPU to communicate with the data analyzer.

According to the present invention, the karaoke receiving device is capable of simultaneously receiving the digital control signal and the voice signal in a wireless manner with two sets of wireless microphones. The voice data are being processed and mixed together with the background music and then transferred to the video/audio device such as amplifier, television or similar audio devices. It is also possible to control the song selecting, playback, recording and similar karaoke feature by the digital control signal of the wireless microphone. The images and lyrics signals are transferred to a display monitor from the video encoder after the data encoding.

While in use, the receiving device can be placed next to a television. The receiving device is capable of receiving the voice and data signals entering in a wireless manner by two sets of wireless microphones. The present invention keeps maintain the images, lyrics, audio playback and other basic karaoke functions of the karaoke microphone (CHINA 200510023918.9). In addition, the present invention eliminates the connecting cable between the karaoke microphone and the television and also reduces the size of the microphone. Therefore, the present invention is convenient and provides an enjoyable experience for the users.

### BRIEF DESCRIPTION OF THE DRAWINGS

FIG. 1 illustrates the connection of the karaoke microphone (CHINA 200510023918.9) and the television.

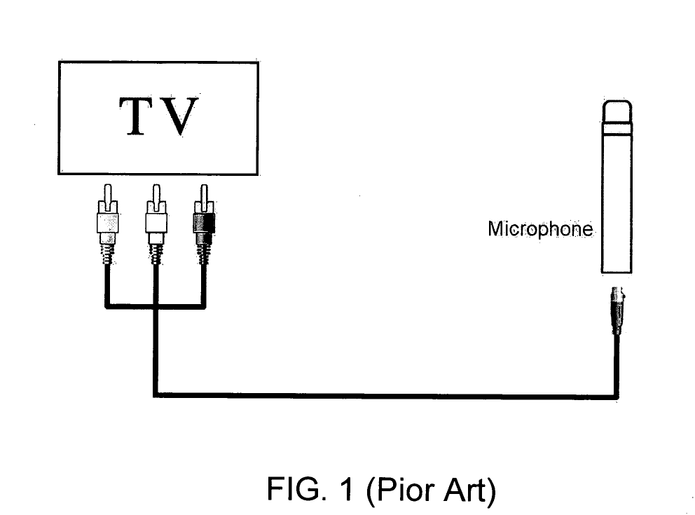

FIG. 2 illustrates the first schematic diagram of the karaoke receiving device.

FIG. 3 illustrates the second schematic diagram of the karaoke receiving device.

FIG. 4 illustrates the third schematic diagram of the karaoke receiving device.

FIG. 5 illustrates the first schematic diagram of the dual channel receiving device of the karaoke receiving device.

FIG. 6 illustrates the second schematic diagram of the dual channel receiving device of the karaoke receiving device.

FIG. 7 illustrates the connection of the karaoke receiving device, the monitor, and the microphone.

### DETAILED DESCRIPTION OF THE PREFERRED EMBODIMENT

In order to illustrate the objects, technology, and effects of the present invention, a detail description of an embodiment of the present invention is shown below. Accordingly, the present invention provides a microphone and a karaoke receiving device for wirelessly connecting the microphone with a video/audio system 10 such as television.

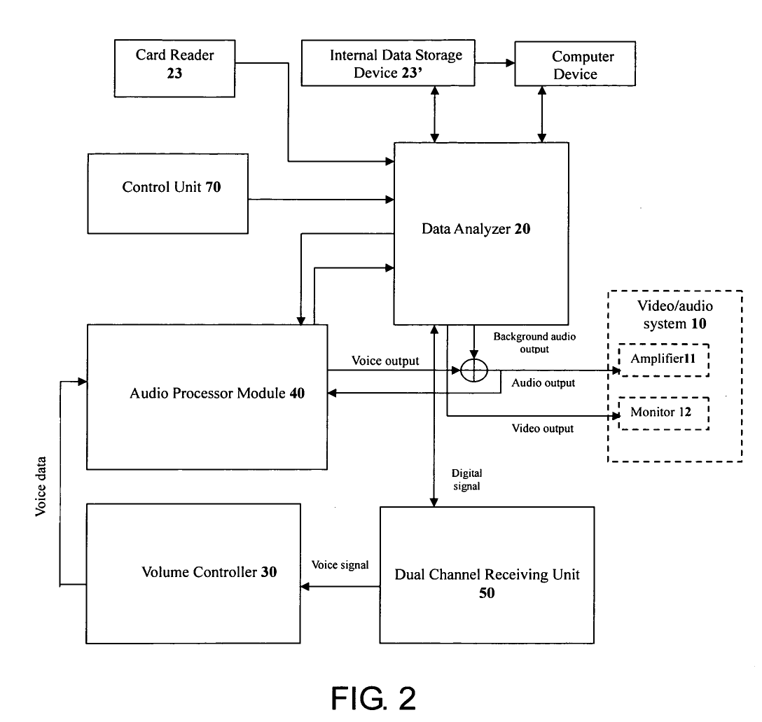

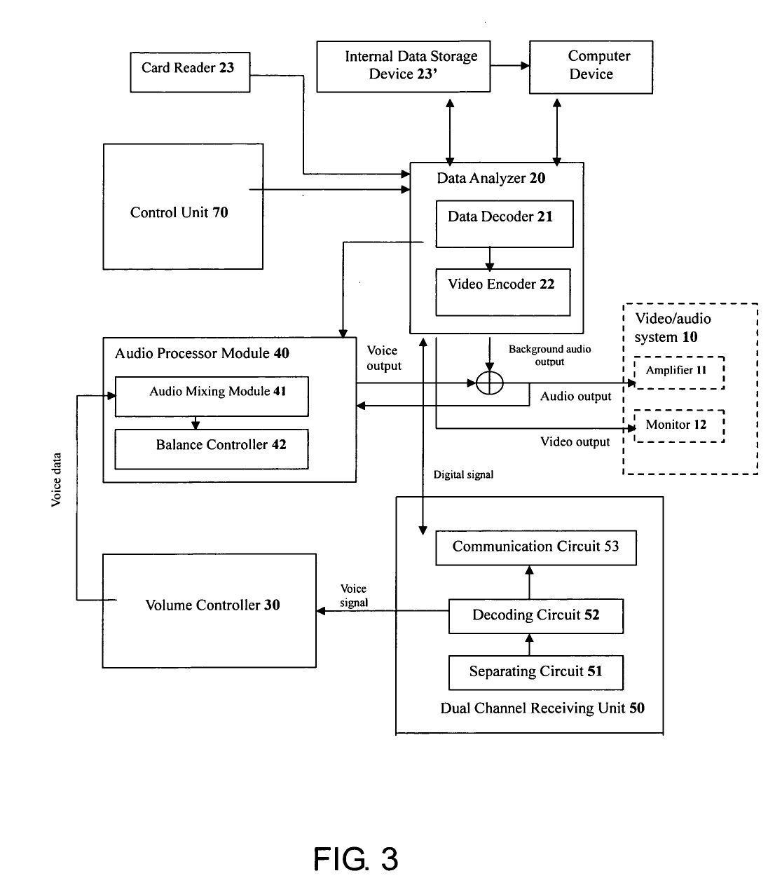

Referring to FIGS. 2 and 3 of the drawings, a karaoke receiving device comprises a data analyzer 20, a volume controller 30, an audio processor module 40, and a dual channel receiving unit 50.

The data analyzer 20 further comprises a data decoder 21 which is capable of decoding a compressed digital data into video data and background audio data, a video encoder 22 which is capable of decoding video data into video output.

The audio processor module 40 comprises an audio mixing module 41 to communicate with the data analyzer 20 and receive background audio data therefrom. The audio mixing module 41 mixes the background audio data and a voice data to form an audio output which is sent to the video/audio system 10, thus enhancing the quality of the audio output.

The dual channel receiving unit 50, which is wirelessly communicating with the microphone, wherein the dual channel receiving unit 50 is adapted for receiving an outputting signal from the microphone and for converting the outputting signal into a digital control signal and the voice signal. The audio processor module processes the voice signal to mix with the background audio data and outputs to the video/audio system.

According to the preferred embodiment, song data are stored after being compressed by the MMD processor. The song data are stored as compressed digital data so as to minimize the storing capacity of each song. The data decoder 21 decodes the compressed digital data into video data and background audio data. According to the MPEG-1 format, the video data comprises video signals and lyrics captions. The video data is encoded by the video encoder 22 and can be converted into video output to the video/audio system 10. Therefore, video signals and lyrics captions are being displayed on a monitor 12 of a video/audio system 10. It is worth to mention that the video data can also be stored as other format such as MPEG-2, so as to enhance the video quality of the compressed digital data.

The volume controller 30 controls the volume and mixing of the singer's voice before the mixing process with the background audio data.

The data analyzer 20 further comprises a card reader 23. The card reader 23 is a port which is capable to read stored media from an external storage device.

As an alternative, an internal data storage device 23′ is installed inside the karaoke receiving device and is also electrically connected to data decoder 21 so that the compressed digital data can be stored at first. The internal data storage device 23′ comprises a computer port which provides a convenient data transfer connection between a computer and the internal data storage device 23′.

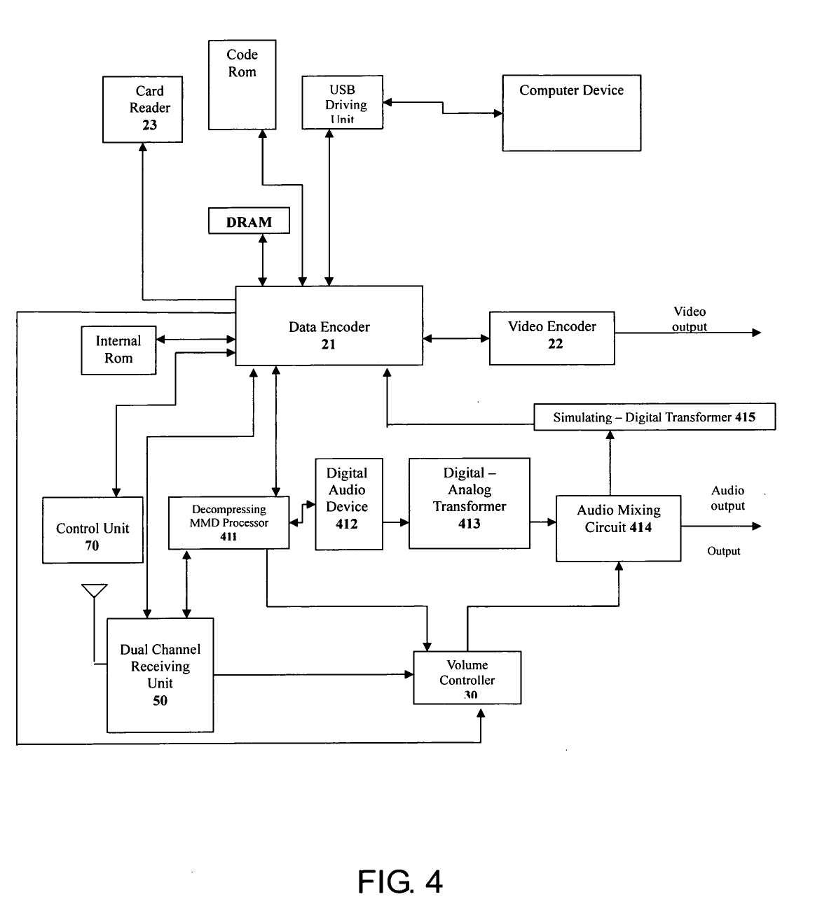

According to FIG. 4 of the drawings, the audio mixing module 41 further comprises an audio mixing circuit 414, which is capable of mixing the background audio data and the voice data to become the audio output, thus enhancing the audio output quality. For correcting the audio output, the audio mixing module 41 further comprises a decompressing MMD processor 411 which decompresses the audio data, a digital audio device 412, and a digital-analog transformer 413. The digital audio device 412 receives the background audio data from the MMD processor 411 to produce the background music in a digital format. The digital-analog transformer 413 helps to transform the audio data from a digital format into a analog format. The advantage of applying a analog-digital transformer 415 is that the data can be transformed into digital format from analog format. After compression, they can be stored in the storage device and become recording.

The advantage of using a USB port is that almost all computers and laptops nowadays supports USB port connection. It is very convenient to download or upload songs to the card reader 23 or the internal data storage device 23′. By reading the data from the card reader 23 directly, no other external card reader is required to establish a connection to the computer. Therefore, USB port can provide a convenient song data transfer to the computer. In addition, it is possible to download background image at the same time and transfer the recorded audio data produced from the analog-digital transformer 415 into the computer.

It is worth to mention that, conventional microphones transfer the video output, the background audio data, and the voice data to the video/audio system 10. Therefore, the mixing process is not performed, thus the quality of the audio output is not improved.

The audio processor module 40 further comprises a balance controller 42 which can balance the volume of the voice signal and background audio data, thus to maximize the quality of the audio output. For example, when the volume of the voice data is lower then the volume of the background audio data, the balance controller 42 can automatically increase the volume of voice data, so as to balance the overall volume.

The karaoke receiving device further comprises a control unit 70 which is electrically connected to the data analyzer. The control unit 70 receives an infrared signal from an external infrared remote control and then transfers to the infrared signal to data analyzer to execute playback, recording, selecting song and other similar function. It is worth to mention that the video output and audio output can be wirelessly sent to the video/audio system 10 by the use of an infrared sending device and an infrared receiving device. It is also possible to use a video/audio cable to connect the karaoke receiving device with the video/audio system 10 so that the video/audio cable can convenient transfer video data and audio data to the video/audio system 10. Therefore, transportation of the karaoke receiving device is more convenient. Users can enjoy karaoke singing by using the karaoke receiving device whenever an amplifier 11 and the monitor 12 are present.

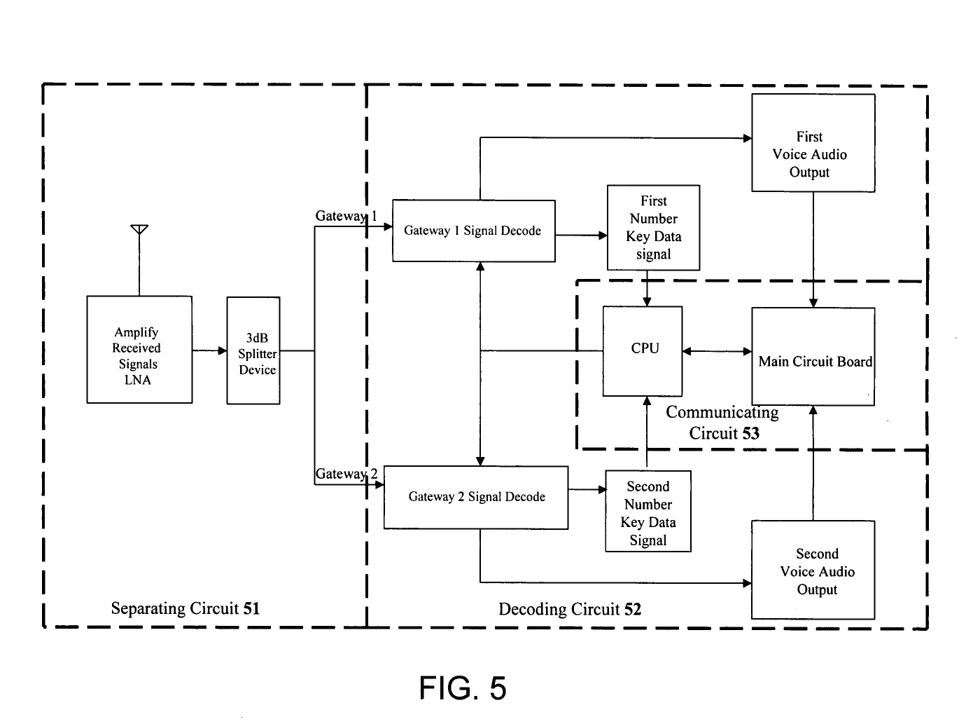

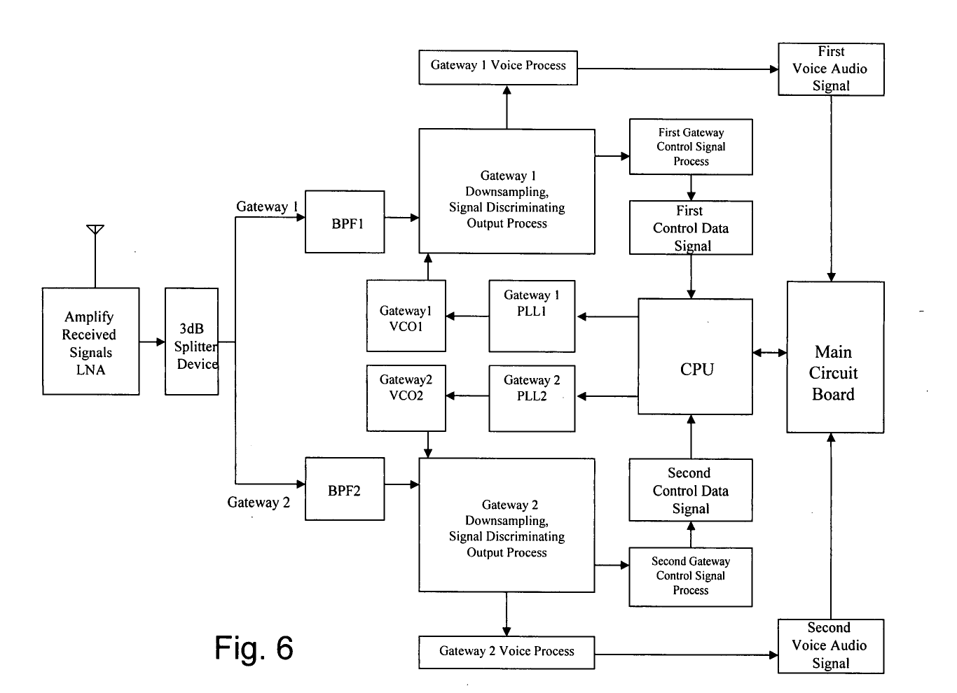

According to FIG. 5 and FIG. 6 of the drawings, the dual channel receiving unit 50 comprises a separating circuit 51 to separate the outputting signal of the microphone to become two gateway signals, a decoding circuit 52 to decode each of the gateway signals, and a communication circuit 53 transmitting the digital control signal to the data analyzer. After decoding from the decoding circuit 52, the gateway signals become a first audio signal and a first digital control signal, and a second audio signal and a second digital control signal. The audio signals after decoding are processed by the volume controller 30. The digital control signals are sent to the data analyzer 20 by the communication circuit 53.

The process of the dual channel receiving unit 50 comprises the following steps:

(1) An splitter device is used to separate the received audio signals to become a first gateway signal and a second gateway signal.

(2) The setting of the first gateway is to use a first phase lock loop PLL1 though the CPU to stabilize a first voltage controlled oscillator VCO1, so as to chose the first gateway.

(3) The setting of the second gateway is to use a second phase lock loop PLL2 though the CPU to stabilize a second voltage controlled oscillator VCO2, so as to chose the second gateway.

(4) After separating the received audio signals, the first gateway signal leaves the first gateway from a first band pass filter BPF1.

(5) After separating the received audio signals, the second gateway signal leaves the second gateway from a second band pass filter BPF2.

(6) The signal that leaves the first gateway follows an output process of downsampling and signal discriminating. Then a first gateway data signal and a first gateway audio signal can be separated from the first gateway signal.

(7) The signal that leaves the second gateway follows an output process of downsampling and signal discriminating. Then a second gateway data signal and a second gateway audio signal can be separated from the second gateway signal.

(8) After the first gateway data signal is being processed by a first gateway control signal process, a first control data signal is produced.

(9) After the second gateway data signal is being processed by a second gateway control signal process, a second control data signal is produced.

(10) After the first gateway audio signal is being processed by a first gateway voice process, a first voice audio signal is produced.

(11) After the second gateway audio signal is being processed by a second gateway voice process, a second voice audio signal is produced;

(12) The first control data signal and the second control data signal produced by the first gateway and the second gateway are directly sent to the CPU. The CPU electrically communicates with the data analyzer 20 of the main circuit board and then the data analyzer 20 processes the respective signals.

(13) The first voice audio signal and the second voice audio signal produced by the first gateway and the second gateways are directly connected to the main circuit board and are being processed by the volume controller 30 of the main circuit board.

The following descriptions further illustrate the prefer embodiment of the present invention:

The voice data is being processed by the dual channel receiving unit 50 first, and then pass through the volume controller 30 and the audio processor module 40, and finally transferred to the video-audio system 10.

The audio processor module 40 is controlled by the data analyzer 20. There are a total of 13 levels that determine the volume and mixing effect of the singer's voice by the audio processor module 40.

The MIDI songs stored inside the card reader 23 and the internal data storage device 23′ are being decoded as background music by the data analyzer 20 and then are sent to the video-audio system 10.

The card reader 23 uses CARD CPU plus the standard ROM, NOR FLASH, NAND FLASH. The CARD CPU uses SIO format to communicate with the data analyzer 20.

The internal data storage device 23′ uses the standard NADN FLASH to communicate with the data analyzer 20.

The volume, melody, tempo, key and similar data value of the music can be controlled and tuned by the data analyzer 20.

The images and words in MPEG1 format stored inside the card reader 23 and the internal data storage device 23′ are decoded by the data analyzer 20 and then are sent to the video-audio system 10.

The internal data storage device 23′ uses a standard NAD FLASH storage device.

The card reader 23 uses CARD CPU plus the standard ROM, NOR FLASH, NAND FLASH.

The video can display a still picture frame of MPEG1 or create its own video playback. Other effects and OSD display can be controlled by the data analyzer 20.

After the process by the audio processor module 40, the audio output signal can be transformed into digital signals that can be saved into a recording card (a type of media that the card reader supports).

The data analyzer 20 can control the recording quality and can also store, playback, or delete the recording.

MP3 Mode:

The MP3 songs that are downloaded into the recording card from a computer can be played from the recording card with the control of the data analyzer 20.

USB Mode:

The data analyzer 20 communicates with a computer device or a PC machine and the PC machine can write the new MPEG1 images and MIDI song into the card reader 23 and the internal data storage device 23′. MP3 songs can be downloaded into the recording card. The data analyzer 20 can also transfer the stored recorded data onto a PC port so that the data analyzer can communicate with the PC port. The USB port also supports the read and write function of the USB saving device. The song data and background image stored inside the USB saving device can be read. The recorded data can also be written into the USB saving device.

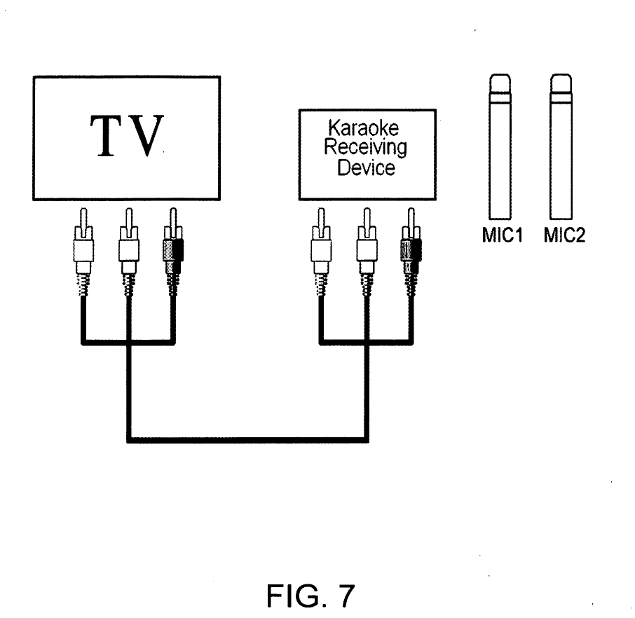

According to FIG. 7 of the drawings, FIG. 7 illustrates the connection relationship between the karaoke receiving device, the monitor, and the karaoke microphone. It is possible that the karaoke receiving device is connected to the monitor and is located very close in location to it also. There are no wire or cable connection between the karaoke microphone and the karaoke receiving device. The karaoke microphone is held by the singer, and the singer does not have to concern about tripping over the connecting cable. In addition, the weight of the karaoke microphone is reduced.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A karaoke receiving device adapted for wirelessly communicating a microphone to a video/audio system, comprising
a data analyzer which comprises a data decoder which is capable of decoding compressed digital data into video data and background audio data, a video encoder which is capable of encoding video data into video signal outputting to said video/audio system;
a volume controller adapted for controlling a volume input from said microphone;
an audio processor module which comprises an audio mixing module electrically communicating with said data analyzer to process said background audio data therefrom; and
a receiving unit, which is wirelessly communicating with the microphone, wherein the receiving unit is adapted for receiving an outputting signal from said microphone and for converting said outputting signal into a digital control signal and a voice signal, wherein said audio processor module processes said voice signal to mix with said background audio data and outputs to the video/audio system.

2. The karaoke receiving device, as recited in claim 1, wherein said receiving unit is also a dual channel receiving unit, comprises a separating circuit to separate said outputting signal of the microphone to become two gateway signals, a decoding circuit to decode each of gateway signals, and a communication circuit transmitting said digital control signal to said data analyzer; after breaking down said outputting signal, said two gateway signals pass through said decoding circuit to form said digital control signal and said voice signal respectively. Then, the volume of said voice signal can be controlled by said volume controller. Said digital control signal is sent to the data analyzer by the communication circuit.

3. The karaoke receiving device, as recited in claim 1, wherein said audio processor module further comprises a balance controller which can automatically balance the volume of said voice signal and background audio data.

4. The karaoke receiving device, as recited in claim 1, wherein said audio mixing module further comprises a decompressing MMD processor which is capable of increasing the storing capacity of said audio mixing module.

5. The karaoke receiving device, as recited in claim 1, wherein said data analyzer further comprises a carder read which is connected to said data decoder, said card reader is used to read the compressed digital data.

6. The karaoke receiving device, as recited in claim 1, wherein said karaoke receiving device further comprises an internal data storage device which is connected to said data decoder, and said internal data storage device is used to store compressed data before the processing, said internal data storage device further comprises a computer connecting port which is capable of transferring data between a computer and said internal data storage device.

7. The karaoke receiving device, as recited in claim 1, wherein said karaoke receiving device further comprises a control unit which is connected to said data analyzer, said control unit receives an infrared signal from an external infrared remote control and then transfer the signal to said data analyzer to execute playback, recording, selecting song and other similar function.

8. The karaoke receiving device, as recited in claim 1, wherein said karaoke receiving device further comprises a USB port which can be electronically connected to the internal data storage device or a computer, said USB port is used to store songs and background images downloaded from a computer and said USB port also supports read and write function for a USB storage device which is capable of storing song, background image, and recording data into said USB storage device.

9. The karaoke receiving device, as recited in claim 5, wherein said card reader uses CARD CPU plus the standard ROM, NOR FLASH, NAND FLASH, said CARD CPU uses S10 format to communicate with said data analyzer.

10. The karaoke receiving device, as recited in claim 2, wherein said audio processor module further comprises a balance controller which can automatically balance the volume of said voice data and background audio data.

11. The karaoke receiving device, as recited in claim 2, wherein said audio mixing module further comprises a decompressing MMD processor which is capable of increasing the storing capacity of said audio mixing module.

12. The karaoke receiving device, as recited in claim 2, wherein said data analyzer further comprises a carder read which is connected to said data decoder, said card reader is used to read the compressed digital data.

13. The karaoke receiving device, as recited in claim 2, wherein said karaoke receiving device further comprises an internal data storage device which is connected to said data decoder, and said internal data storage device is used to store compressed data before the processing, said internal data storage device further comprises a computer connecting port which is capable of transferring data between a computer and said internal data storage device.

14. The karaoke receiving device, as recited in claim 2, wherein said karaoke receiving device further comprises a control unit which is connected to said data analyzer, said control unit receives an infrared signal from an external infrared remote control and then transfer the signal to said data analyzer to execute playback, recording, selecting song and other similar function.

15. The karaoke receiving device, as recited in claim 2, wherein said karaoke receiving device further comprises a USB port which can be electronically connected to the internal data storage device or a computer, said USB port is used to store songs and background images downloaded from a computer and said USB port also supports read and write function for a USB storage device which is capable of storing song, background image, and recording data into said USB storage device.

16. The karaoke receiving device, as recited in claim 12, wherein said card reader uses CARD CPU plus the standard ROM, NOR FLASH, NAND FLASH, said CARD CPU uses S10 format to communicate with said data analyzer.
